(19) United States
(12) Patent Application Publication
(10) Pub. No.: US 2007/0025394 A1
(43) Pub. Date: Feb. 1, 2007

(54) Layer one control architecture

(75) Inventor: Eric Mascio, Bethpage, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/257,697

(22) Filed: Oct. 25, 2005

Related U.S. Application Data
(60) Provisional application No. 60/704,512, filed on Aug. 1, 2005.

(51) Int. Cl. H04J 3/16

(52) U.S. Cl. 370/469

(57) ABSTRACT

A layer 1 control (L1C) architecture which processes radio link (RL) requests received from a layer 3 (L3) radio resource control (RRC), and physical data requests received from a layer 2 (L2) medium access control (MAC). The L1C architecture includes a mode connection controller (MCC) unit, a transmit/receive unit, a transmit frame scheduler (FS) unit and a receive FS router. The L1C architecture further includes an L1C database, a transmit frame table, a receive frame table and a frame counter database. The receive FS router accesses control messages received from a processor which implements layer 1 processing (L1P) and routes the control messages to the MCC unit and the transmit/receive unit. The transmit FS unit forwards control or data messages received from the transmit frame table to the processor. The frame counter database provides frame numbering services for use by any L1C process based on an L1P-generated L1 frame number.

### CROSS REFERENCE TO RELATED APPLICATION

This application claims the benefit of U.S. provisional application No. 60/704,512 filed Aug. 1, 2005, which is incorporated by reference as if fully set forth.

### FIELD OF INVENTION

The present invention is related to an apparatus for processing and storing control and data messages. More particularly, the present invention is related to a first processor, (e.g., a microprocessor unit (MPU)), including a Layer 1 Control (L1C) architecture, a radio resource control (RRC) and a medium access control (MAC), which interfaces with interrupt service routines (ISRs) and a second processor, (e.g., a digital signal processor (DSP)), on which layer 1 processing (L1P) is implemented.

### BACKGROUND

In conventional wireless communication systems, a protocol stack is designed in layers. Each layer has unique requirements. The layers may be running on physically separated hardware and software systems. A layer of software that interfaces with and supports the requirements of the upper layers, such as a Layer 3 (L3) RRC and a Layer 2 (L2) MAC, must also interface and support the lower layer requirements of the Layer 1 (L1) physical (PHY) software and hardware. These requirements are defined in the third generation (3G) Specifications.

A more efficient architecture for alleviating the burden of processing and memory requirements on L1to improve overall system performance is desired.

### SUMMARY

The present invention is related to an L1C architecture which processes radio link (RL) requests received from an L3 RRC, and physical data requests received from an L2MAC. The L1C architecture includes a mode connection controller (MCC) unit, a transmit/receive unit, a transmit frame scheduler (FS) unit and a receive FS router. The L1C architecture further includes an L1C database, a transmit frame table, a receive frame table and a frame counter database. The receive FS router accesses control messages received from a processor which implements layer 1 processing (L1P) and routes the control messages to the MCC unit and the transmit/receive unit. The transmit FS unit forwards control or data messages received from the transmit frame table to the processor. The frame counter database provides frame numbering services for use by any L1C process based on an L1P-generated L1frame number.

Each of the MCC, the transmit/receive unit, the transmit FS and the receive FS router is assigned a priority level. The MCC handles configuration and other non-data application programming interfaces (APIs), and processes requests received from an RRC layer. Physical Data Requests received from a MAC layer and Physical Data Indications received from L1P are processed by the transmit/receive unit. Messages stored in the transmit frame table are processed by the transmit FS. Messages stored in the receive frame table are processed by the receive FS router. The frame counter database provides frame numbering services.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a high-level diagram of a multi-layer protocol stack including Upper Layers (L2, L3) and a Physical Layer (L1) with a Layer 1 Control (L1C) sub-layer and an L1P sub-layer in accordance with the present invention; and

FIGS. 2A-2C show details of the architecture of each of the layers and sub-layers of the multi-layer protocol stack of FIG. 1.

### DETAILED DESCRIPTION OF THE PREFERRED EMBODIMENTS

Hereafter, the terminology “WTRU” includes but is not limited to a user equipment (UE), a mobile station, a laptop, a personal data assistant (PDA), a fixed or mobile subscriber unit, a pager, or any other type of device capable of operating in a wireless environment. When referred to hereafter, the terminology “base station” includes but is not limited to a Node-B, a site controller, an access point (AP) or any other type of interfacing device in a wireless environment.

The features of the present invention may be incorporated into an integrated circuit (IC) or be configured in a circuit comprising a multitude of interconnecting components.

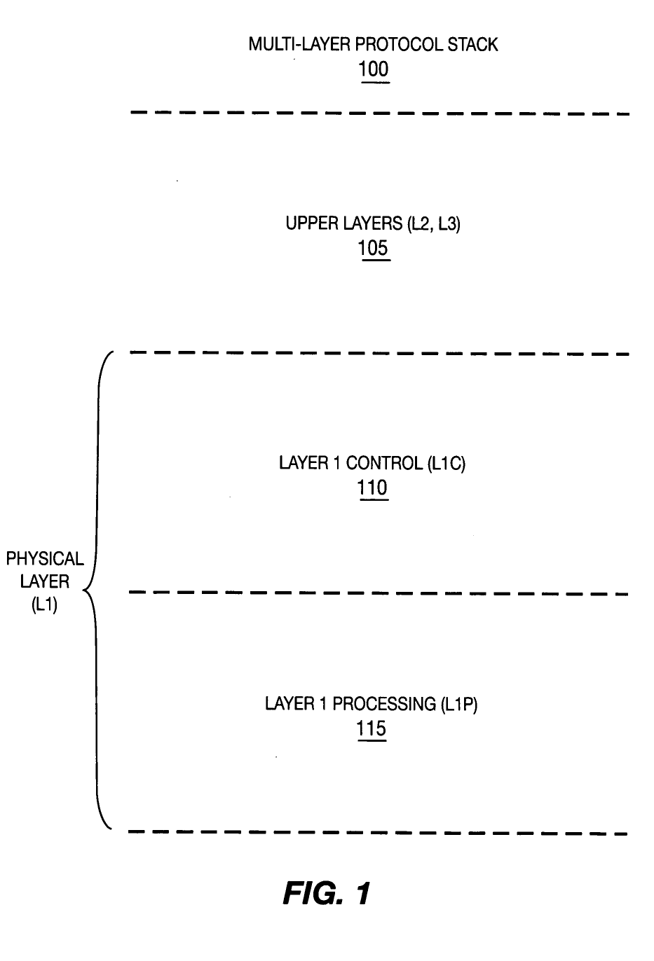

FIG. 1 is a high-level diagram of a multi-layer protocol stack 100 including Upper Layers (L2, L3) 105 and a Physical Layer (L1). The Physical Layer (L1) is implemented in DSP software and hardware. L1 is separated into two sub-layers: L1C 110, which is a small portion of L1, and L1P 115.

In accordance with the present invention, a shared memory scheme is implemented such that a section of memory is accessible by two or more MPUs or DSPs, whereby an L1C Link Handler hides the details of these memory accesses. If the memory scheme changes, then the internal details of the Link Handler would also change.

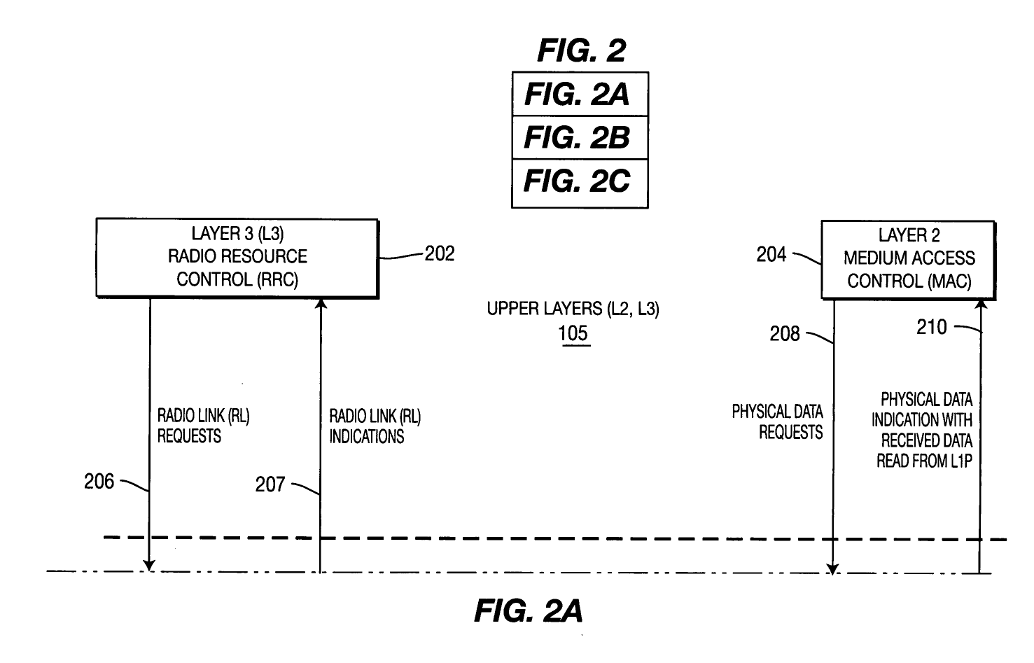

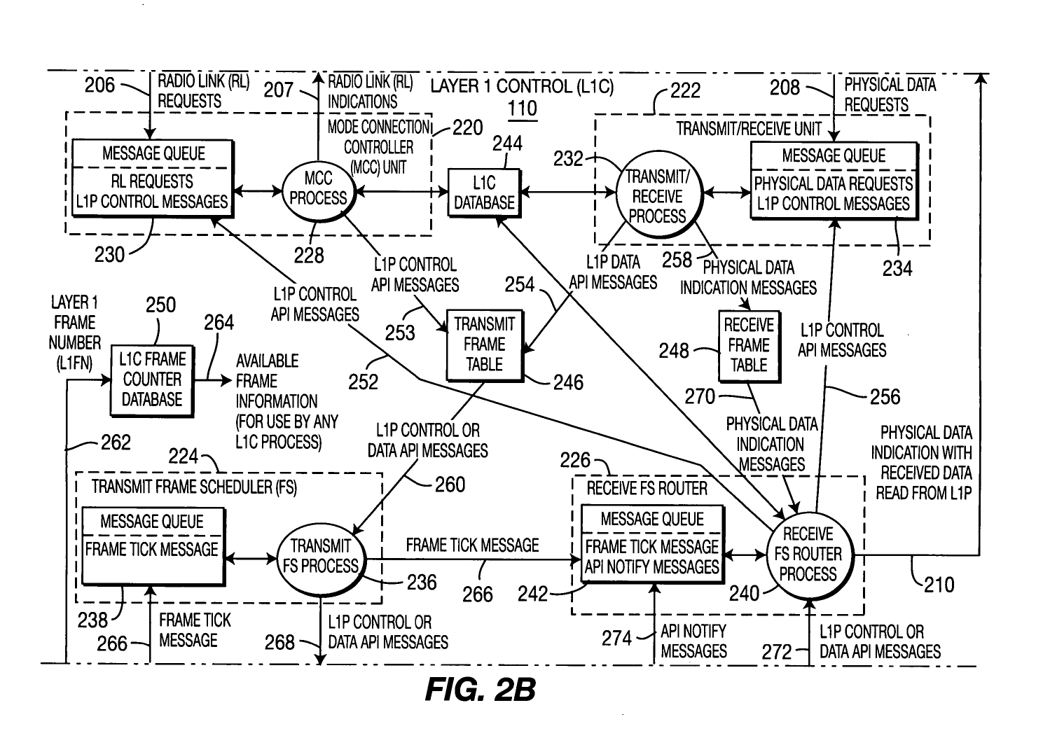

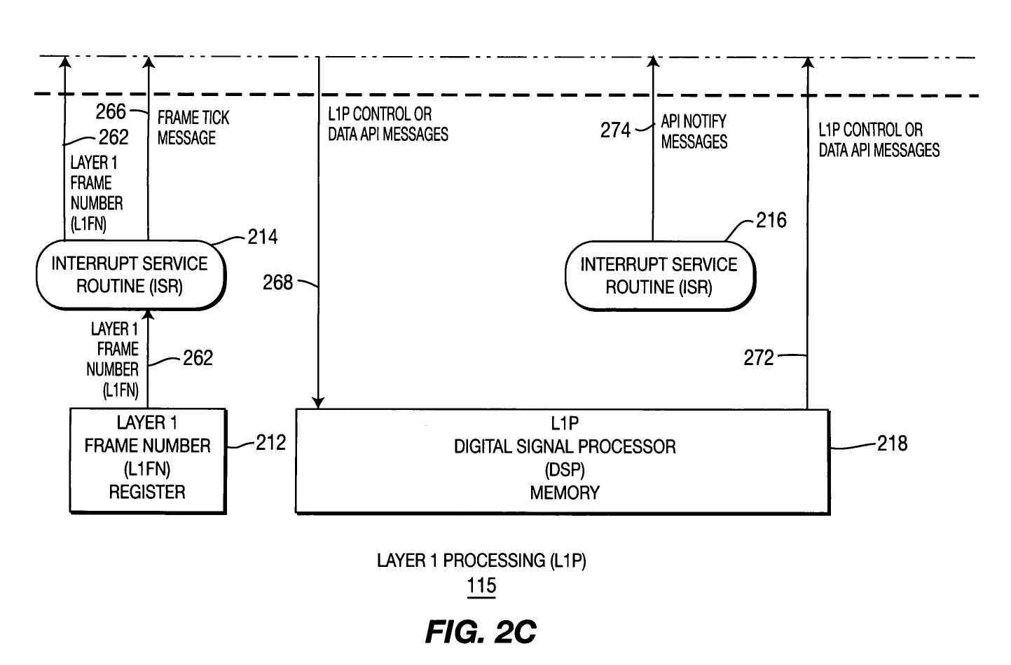

As shown in FIG. 2A, the Upper Layers (L2, L3) 105 include an L3 RRC 202 and an L2 MAC 204. The L3 RRC 202 generates RL requests 206 and the L2 MAC 204 generates physical data requests 208. The L2 MAC receives a signal 210 including a Physical Data Indication with received data read from the L1P 115 via the L1C 110. The L2 MAC 204 and the L3 RRC 202 reside in software of an MPU.

As shown in FIG. 2C, the L1P 115 includes an L1frame number (L1FN) register 212, interrupt service routines 214 and 216, and an L1P DSP memory 218. A detailed description of the L1P 115 will be further described in conjunction with the description of L1C 110 provided below.

FIG. 2B shows the architecture of the L1C 110 in accordance with the present invention. The L1C 110 interfaces with the L1P 115 and the Upper Layers (L2, L3) 105. Since resources are limited on the DSP and, in order to make transparent to L2 and L3 where L1is located, the L1C 110 is located on, (i.e., incorporated in), the MPU along with the L2MAC 204 and the L3RRC 202.

The present invention addresses the architecture of the L1C 110. The following description often refers to signals of data coming from or going to the Upper Layers (L2, L3) 105 and the L1P 115. In accordance with the present invention, the L1C architecture has four processes, four message queues and four internally shared databases/tables. A process is a thread or task that is a schedulable path of execution within an executable module. The processes have a shared memory space.

Each process has a corresponding message queue to facilitate inter-process communication between L1C processes and processes of other layers, (i.e., the RRC, the MAC and ISRs). There are several L1 control processes which interact with other processes and share resources. Each process has a priority level based on criticality and length of processing time to complete its function.

In the overall architecture of the L1P 115 of FIG. 2C, control signaling paths are used to setup communication channels over a wireless medium, and data signaling paths are used to send and receive data over a plurality communication channels, (i.e., RL channels). The L3 RRC 202 requests the L1P 115 to setup/tear down the channels thru RL Requests 206. The L2 MAC 204 requests data transmissions through physical Data Requests 208. Received data is provided to the L1C 110 from the L1P 115.

As shown in FIG. 2B, the L1C 110 includes a mode connection controller (MCC) unit 220, a transmit/receive unit 222, a transmit FS 224 and a receive FS router 226. The MCC unit 220 includes an MCC process 228 and a message queue 230. The transmit/receive unit 222 includes a transmit/receive process 232 and a message queue 234. The transmit FS 224 includes a transmit FS process 236 and a message queue 238. The receive FS router 226 includes a receive FS router process 240 and a message queue 242. The L1C 110 further includes an L1C database 244, a transmit frame table 246, a receive frame table 248 and an L1C frame counter database 250.

As shown in FIGS. 2A and 2B, the RL requests 206 enter the L1C 110 from the L3 RRC 202 and are received and queued at the message queue 230 of the MCC unit 220. The message queue 230 is in communication with the MCC process 228. The RL requests 206 contain detailed information about the RL channel being requested. The RL channel detailed information is passed from the MCC process 228 to the L1C database 244. The RL channel detailed information is also passed to the L1P 115 on the DSP. The purpose of storing the RL channel detailed information in the L1C database 244 is to track which RL channels are configured and how they are configured. The L1P 115 does not have the memory or processing resources to store and track this information. In addition, the L1C 110 reformats the RL requests 206 received from the L3 RRC 202 into a format that allows the L1P 115 to process the information more efficiently.

As mentioned above, the L1C database 244 is used to maintain RL configuration information. Part of that function is to cross-reference a RL coded composite transport channel identifier (CCTRCHID) used by the Upper Layers (L2, L3) 105 with “L1P channel identifiers.” The different layers use different numbering systems to refer to the same channels. Coded composite channel identifiers are defined in the 3GPP specification. Part of the L1C 110 requirements is to be able to convert between these numbering systems. The RL configuration information is arranged into records, one record per RL. The RL records are organized and stored in the L1C database 244 by their RL CCTRCHID number.

The transmit frame table 246 is used to buffer messages that need to be transferred to the L1P 115 at a delayed time from when an RL request 206 from the L3 RRC 202 or a Physical Data Request 208 from the L2 MAC 204 enter the L1C 110. The transmit frame table 246 is an array table keyed on L1 Frame Numbers (L1FNs). Each array entry contains a data structure. Within that structure are two linked lists of messages and a semaphore. One message list is used to store control messages and the other list is used to store data messages. Since the table is accessed by multiple processes, access synchronization is achieved by use of the semaphore in the data structure.

The RL requests 206 are sent by the L3 RRC 202 to initiate a cell search, initializing hardware, configuring measurements, power control, configuring the sync channel, configuring an RL connection, timing advance, re-sync a time division duplex (TDD) cell, and pinging for test purposes.

The message queue 230 in the MCC unit 220 also receives L1P control API messages 252 from the Receive FS Router process 240. The control L1P control API messages 252 may include information to be used at the L1C 110 or to be sent as RL indications 207 to the L3 RRC 202 in response to the RL requests 206. L1P control API messages 253 that are to be transmitted to the L1P 115 are placed in the transmit frame table 246 by the MCC process 228.

As shown in FIGS. 2A and 2B, the Physical Data Requests 208 enter the L1C 110 from the L2 MAC 204 and are received and queued at the message queue 234 of the transmit/receive unit 222. The message queue 234 is in communication with the transmit/receive process 232. The transmit/receive process 232 includes a transmit function and a receive function. The transmit function of the transmit/receive process 232 processes the Physical Data Requests 208. This is achieved by using the L1C database 244 for lookup of L1P identifiers, and the transmit frame table 246. L1P data API messages 254 that are to be transmitted to the L1P 115 are placed in the transmit frame table 246 by the transmit/receive process 232. The L1P data API messages 254 are added to the transmit frame table 246 at an adjusted activation frame number. The transmit function of the transmit/receive process 232 is also responsible for recognizing Physical Data Requests 208 received from the L2 MAC 204 that are designated for a random access channel (RACH). In this case, the transmit/receive process 232 dynamically configures the physical random access channel (PRACH) prior to adding the L1P data API messages 254 to the transmit frame table 246. The RL channel configuration is normally performed by the RL requests 206 and the MCC unit 220. Alternatively, the Physical Data Requests 208 and the transmit/receive unit 222 may be used.

The receive function of the transmit/receive process 232 processes L1P control API messages 256 received by the message queue 234 from the receive FS router process 240. These L1P control API messages 256 are specifically configured to indicate the arrival of data over the wireless medium on one of the previously configured channels, (configured via the RL requests 206 and the MCC unit 220). The L1P control API messages 256 do not contain data itself, but contain information about the data, including the DSP addresses of the transport blocks that are copied from the DSP to the MPU, and the frame number of when the data should be read from an L1P DSP memory. The transmit/receive process 232 is responsible for allocating memory on the MPU, cross referencing CCTRCHID numbers with “L1P channel identifiers” via the L1C database 244, configuring the messages into MAC Physical Data Indication format, making calculations as to the quality of the data, and placing L1P data API messages 258 in the receive frame table 248 at the location indicated by the frame numbers included with the original L1P control API messages 256.

The receive frame table 248 is used to buffer messages that need to be transferred from the L1P 115 at a delayed time from when the Physical Data Requests enter the L1C 110. The receive frame table 248 is structurally identical to the transmit frame table 246.

In the transmit FS 224, the transmit FS process 236 is in communication with the message queue 238. The transmit FS 224 is responsible for processing L1P control or data API messages 260 stored in the transmit frame table 246. As shown in FIGS. 2B and 2C, the L1FN register 212 forwards LIFN information 262 to the L1C frame counter database 250 via the ISR 214. The L1C frame counter database 250 provides available frame information 264 for use by any L1C process. The ISR 212 also provides a frame tick message 266 to the message queue 238 of the transmit FS 224. The transmit FS process 236 starts a transmit FS cycle is started on each frame tick message 266 received from the message queue and forwards the frame tick message 266 to the message queue 242 of the receive FS router 226.

Each frame tick advances the L1FN, and therefore the current L1FN. The L1P control or data API messages listed in the transmit frame table 246 for the current frame number, are removed and sent to the L1P DSP memory 218 via the path 260, the transmit FS process 236 and path 268.

The receive FS router process 240 is responsible for processing messages in the receive frame table 248, routing L1P control API messages 252 to the message queue 230 of the MCC unit 220, and also routing L1P control API messages 256 to the message queue 234 of the transmit/receive unit 232 for further action.

Processing of the messages in the receive frame table 248 is initiated by receipt of a frame tick message 266 by the message queue 242 of the receive FS router 226 from the transmit FS process 236 of the transmit FS 224. The receive FS router process 240 reads Physical Data Indication messages 270 received from the receive frame table 248 at the location indicated by the frame number in the frame tick message 266. Thus, data transport blocks are read from the L1P DSP memory 218 into the MPU memory, (allocated earlier by the receive function of the transmit/receive process 222). The details of the transfer are managed by a link handler over a DMA channel. The L1P control or data API messages 272 read from the L1P DSP memory 218 are combined with the Physical Data Indication messages 270 and are then sent as a signal 210, which includes Physical Data Indication with received data read from the L1P 115, to the L2 MAC 204. The ISR 216 sends API notify messages 274 to the message queue 242 of the receive FS router 226. An API notify message 274 indicates to the L1C 110 that data or control messages are available in the memory of the L1P 115. The L1C 110 then reads these messages from the L1P memory via a link handler mechanism.

The L1C frame counter database 250 is used to track the current value of the L1FN, as designated by the L1FN register 212, and provides available frame information 264 to support all services related to frame numbering. These services include conversion to other frame number types, system frame number (SFN) and connection frame number (CFN) as identified in the 3G specifications, and to calculate the adjusted frame numbers used to add messages to the frame tables.

Data transfer has the highest priority and is distributed over three L1C processes. Therefore the transmit FS process 236, and the receive FS router process 240 are assigned the highest priorities. The transmit/receive process 232 is assigned a medium priority. The MCC process 228, which handles configuration and other non-data transfer APIs, is assigned the lowest priority.

All of the processes; the receive FS router process 240, the transmit/receive process 232, the transmit FS process 236 and the MCC process 228; are responsible for initializing themselves at startup, (i.e., as soon as the processes are started by the operating system and before the processes enter their initial state). Initialization consists of setting any of their local variables as required. In addition to the above initialization activity, the MCC process 228 is responsible for initializing all of the databases.

In another embodiment, the transmit frame table 246 and the receive frame table 248 may reside in a memory that can be shared directly by the two L1 sub-Layers, (i.e., L1C 110 and L1P 115). In this way, some of the L1C 110 functionality is moved to the L1P 114. Specifically, the portion of the transmit FS process 236 that functions as a consumer of the transmit frame table 246 and the portion of the receive FS router process 240 that is a producer of L1P messages 272 onto the receive frame table 248 would then be allocated to the L1P 115 architecture. Thus, a partial shifting of functionality may take place between the L1C 110 and the L1P 115.

In another embodiment, the transmit/receive process 232 may be split into two separate processes. One process handles the transmit data functionality, interfaces with the L2 MAC 204 and adds messages to the transmit frame table 246. The second process handles the receive data functionality.

In yet another embodiment, the receive FS router process 240 is split into two processes. One for the receive FS to handle the received data, and the other for the router to handle identifying of messages sent from the L1P 115 and routing them to the correct L1C process for further action.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A layer 1 control (L1C) architecture for interfacing with a memory, the L1C architecture comprising:
(a) a mode connection controller (MCC) unit for receiving radio link (RL) requests from a layer 3 (L3) radio resource control (RRC) and generating control messages;
(b) a transmit/receive unit for receiving physical data requests from a layer 2 (L2) medium access control (MAC) and generating data messages; and
(c) a transmit frame table for receiving and storing the control and data messages, wherein the control and data messages are transferred to the memory at a delayed time from when the RL requests are received by the MCC unit and the physical data requests are received by the transmit/receive unit.

2. The L1C architecture of claim 1 further comprising:
(d) a transmit frame scheduler (FS) unit in communication with the transmit frame table and the memory;
(e) a receive FS router in communication with the transmit FS unit, the MCC unit, the transmit/receive unit and the memory, the receive FS router for receiving control messages from the memory and routing the received control messages to the MCC unit and the transmit/receive unit; and
(f) an L1C database in communication with the MCC unit, the transmit/receive unit and the receive FS router, the L1C database for maintaining RL configuration information.

3. The L1C architecture of claim 2 wherein each of the MCC unit, the transmit/receive unit, the transmit FS unit and the receive FS router is assigned a priority level based on the criticality and length of processing time to complete the functions of the components.

4. The L1C architecture of claim 3 wherein the transmit FS unit and the receive FS router are assigned the highest priorities.

5. The L1C architecture of claim 3 wherein the transmit/receive unit is assigned a medium priority.

6. The L1C architecture of claim 3 wherein the MCC unit is assigned a lower priority than the transmit FS unit, the receive FS router and the transmit/receive unit.

7. The L1C architecture of claim 1 wherein the MCC unit handles configuration and other non-data application programming interfaces (APIs).

8. The L1C architecture of claim 1 wherein each of the MCC unit, the transmit/receive unit, the transmit FS unit and the receive FS router has a message queue to facilitate inter-process communication between L1C processes and processes of other layers.

9. The L1C architecture of claim 2 further comprising a frame counter database which receives L1 frame number (L1FN) information from an interrupt service routine (ISR) and provides available frame information for use by at least one of the MCC unit, the transmit/receive unit, the transmit FS unit and the receive FS router.

10. The L1C architecture of claim 2 wherein the receive FS router receives control messages from the memory and routes the control messages to the MCC unit and the transmit/receive unit.

11. The L1C architecture of claim 1 wherein the memory is a digital signal processor (DSP) memory.

12. The L1C architecture of claim 2 wherein the transmit FS unit processes messages stored in the transmit frame table.

13. The L1C architecture of claim 2 further comprising a receive frame table in communication with the transmit/receive unit and the receive FS router, wherein the transmit/receive unit sends data messages to the receive frame table for.

14. The L1C architecture of claim 13 further comprising a frame counter database for providing services related to frame numbering.

15. The L1C architecture of claim 14 wherein the receive frame table provides services for storing lists of messages based on a frame number or time at which the messages were received over a wireless medium.

16. The L1C architecture of claim 1 wherein the transmit frame table provides services for storing lists of messages based on a frame number or time at which the messages need to be transmitted over a wireless medium.

17. The L1C architecture of claim 2 wherein the L1C database provides services for storing information and provides synchronization for multiple processes which simultaneously access the L1C database.

18. An apparatus for storing and processing control and data messages, the apparatus comprising:
(a) a first processor; and
(b) a second processor in communication with the first processor, the first processor comprising:
(b1) a radio resource control (RRC) for generating radio link (RL) requests;
(b2) a medium access control (MAC) for generating physical data requests;
(b3) a mode connection controller (MCC) unit including a first message queue and an MCC process;
(b4) a transmit/receive unit including a second message queue and a transmit/receive process;
(b5) a receive frame scheduler (FS) router including a third message queue and a receive FS router process, the receive FS router process accessing control messages from the first processor and routing the control messages to the first and second message queues;
(b6) a layer 1 control (L1C) database in communication with the MCC process, the transmit/receive process and the receive FS router process;
(b7) a transmit frame table for receiving and storing control messages sent by the MCC process and the transmit/receive process;
(b8) a receive frame table for receiving and storing data messages sent by the transmit/receive process; and
(b9) a transmit FS unit including a fourth message queue and a transmit FS process, the transmit FS unit receiving control or data messages from the transmit frame table and forwarding the received control or data messages to the first processor.

19. The apparatus of claim 18 wherein layer 1 processing (L1P) is implemented by the first processor.

20. The apparatus of claim 18 wherein the L1C database is used to maintain RL configuration information.

21. The apparatus of claim 18 wherein the transmit frame table is used to buffer messages that need to be transferred to the first processor at a delayed time from when an RL request is received by the MCC unit.

22. The apparatus of claim 18 wherein the transmit frame table is used to buffer messages that need to be transferred to the first processor at a delayed time from when a physical data request is received by the transmit/receive unit.

23. The apparatus of claim 18 wherein the second processor further comprises:
(b10) a frame counter database for generating frame information based on a layer 1 frame number (L1FN).

24. A wireless transmit/receive unit (WTRU) comprising:
(a) a first processor; and
(b) a second processor in communication with the first processor, the first processor comprising:
(b1) a radio resource control (RRC) for generating radio link (RL) requests;
(b2) a medium access control (MAC) for generating physical data requests;
(b3) a mode connection controller (MCC) unit including a first message queue and an MCC process;
(b4) a transmit/receive unit including a second message queue and a transmit/receive process;
(b5) a receive frame scheduler (FS) router including a third message queue and a receive FS router process, the receive FS router process accessing control messages from the first processor and routing the control messages to the first and second message queues;
(b6) a layer 1 control (L1C) database in communication with the MCC process, the transmit/receive process and the receive FS router process;
(b7) a transmit frame table for receiving and storing control messages sent by the MCC process and the transmit/receive process;
(b8) a receive frame table for receiving and storing data messages sent by the transmit/receive process; and
(b9) a transmit FS unit including a fourth message queue and a transmit FS process, the transmit FS unit receiving control or data messages from the transmit frame table and forwarding the received control or data messages to the first processor.

25. The WTRU of claim 24 wherein layer 1 processing (L1P) is implemented by the first processor.

26. The WTRU of claim 24 wherein the L1C database is used to maintain RL configuration information.

27. The WTRU of claim 24 wherein the transmit frame table is used to buffer messages that need to be transferred to the first processor at a delayed time from when an RL request is received by the MCC unit.

28. The WTRU of claim 24 wherein the transmit frame table is used to buffer messages that need to be transferred to the first processor at a delayed time from when a physical data request is received by the transmit/receive unit.

29. The WTRU of claim 24 wherein the second processor further comprises:
(b10) a frame counter database for generating frame information based on a layer 1 frame number (L1FN).

30. In a wireless transmit/receive unit (WTRU) including a processor, an integrated circuit (IC) in communication with the processor, the IC comprising:
(a) a radio resource control (RRC) for generating radio link (RL) requests;
(b) a medium access control (MAC) for generating physical data requests;
(c) a mode connection controller (MCC) unit including a first message queue and an MCC process;
(d) a transmit/receive unit including a second message queue and a transmit/receive process; and
(e) a receive frame scheduler (FS) router including a third message queue and a receive FS router process, the receive FS router process accessing control messages from the processor and routing the control messages to the first and second message queues.

31. The IC of claim 30 further comprising:
(f) a layer 1 control (L1C) database in communication with the MCC process, the transmit/receive process and the receive FS router process;
(g) a transmit frame table for receiving and storing control messages sent by the MCC process and the transmit/receive process;
(h) a receive frame table for receiving and storing data messages sent by the transmit/receive process; and
(i) a transmit FS unit including a fourth message queue and a transmit FS process, the transmit FS unit receiving control or data messages from the transmit frame table and forwarding the received control or data messages to the processor.

32. The IC of claim 31 wherein layer 1 processing (L1P) is implemented by the processor.

33. The IC of claim 31 wherein the L1C database is used to maintain RL configuration information.

34. The IC of claim 31 wherein the transmit frame table is used to buffer messages that need to be transferred to the processor at a delayed time from when an RL request is received by the MCC unit.

35. The IC of claim 31 wherein the transmit frame table is used to buffer messages that need to be transferred to the processor at a delayed time from when a physical data request is received by the transmit/receive unit.

36. The IC of claim 31 further comprising:
(j) a frame counter database for generating frame information based on a layer 1 frame number (L1FN).
